(19) United States
(12) Patent Application Publication
(10) Pub. No.: US 2025/0138307 A1
(43) Pub. Date: May 1, 2025

(54) Self-Cleaning Optical Component

(71) Applicant: Envisics Ltd, Milton Keynes (GB)

(72) Inventor: Michael Spurr, Milton Keynes (GB)

(21) Appl. No.: 18/915,614

(22) Filed: Oct. 15, 2024

(30) Foreign Application Priority Data
Oct. 30, 2023 (GB) 2316547.5

(51) Int. Cl. G02B 27/00; B60K 35/23; G02B 27/01

(52) U.S. Cl. CPC G02B 27/0006; B60K 35/23; G02B 27/0103; B60K 2360/29; B60K 2360/31; G02B 2027/0109; G02B 2027/011; G02B 2027/014

(57) ABSTRACT

A head-up display for a vehicle comprises a spatial light modulator arranged to form a spatially modulated wavefront, and an optical sub-system arranged to direct the spatially modulated wavefront to an eye-box. The optical sub-system comprises an optical component having an external surface arranged to output the spatially modulated wavefront to the eye-box. At least part of the external surface of the optical component comprises a superhydrophobic surface structure, such as hierarchical micro-nanostructures.

### CROSS-REFERENCE TO RELATED APPLICATIONS

The present application claims priority under 35 U.S.C. § 119 to UK Patent Application GB 2316547.5 titled “Self-Cleaning Optical Component,” filed on Oct. 30, 2023, and currently pending. The entire contents of GB 2316547.5 are incorporated by reference herein for all purposes

### FIELD

The present disclosure relates to an optical component for a display. More particularly, the present disclosure relates to a self-cleaning optical component for a display. Some embodiments relate to a glare mitigation component, a light turning component and/or a waveguide for a display arranged with a superhydrophobic output surface for self-cleaning. Some embodiments relate to a holographic display, such as a holographic head-up display for a vehicle, comprising a self-cleaning optical component, such as a waveguide, having a superhydrophobic output surface.

### INTRODUCTION

Light scattered from an object contains both amplitude and phase information. This amplitude and phase information can be captured on, for example, a photosensitive plate by well-known interference techniques to form a holographic recording, or “hologram”, comprising interference fringes. The hologram may be reconstructed by illumination with suitable light to form a two-dimensional or three-dimensional holographic reconstruction, or replay image, representative of the original object.

Computer-generated holography may numerically simulate the interference process. A computer-generated hologram may be calculated by a technique based on a mathematical transformation such as a Fresnel or Fourier transform. These types of holograms may be referred to as Fresnel/Fourier transform holograms or simply Fresnel/Fourier holograms. A Fourier hologram may be considered a Fourier domain/plane representation of the object or a frequency domain/plane representation of the object. A computer-generated hologram may also be calculated by coherent ray tracing or a point cloud technique, for example.

A computer-generated hologram may be encoded on a spatial light modulator arranged to modulate the amplitude and/or phase of incident light. Light modulation may be achieved using electrically-addressable liquid crystals, optically-addressable liquid crystals or micro-mirrors, for example.

A spatial light modulator typically comprises a plurality of individually-addressable pixels which may also be referred to as cells or elements. The light modulation scheme may be binary, multilevel or continuous. Alternatively, the device may be continuous (i.e. is not comprised of pixels) and light modulation may therefore be continuous across the device. The spatial light modulator may be reflective meaning that modulated light is output in reflection. The spatial light modulator may equally be transmissive meaning that modulated light is output in transmission.

A holographic projector may be provided using the system described herein. Such projectors have found application in head-up displays, “HUD”.

### SUMMARY

Aspects of the present disclosure are defined in the appended independent claims.

Broadly, the disclosure relates to a head-up display comprising a spatial light modulator arranged to form a spatially modulated light. The head-up display further comprises an optical sub-system arranged to direct the spatially modulated light to an eye-box. The optical sub-system comprises an optical component having an external surface arranged to output the spatially modulated light to the eye-box. At least a part of the external surface of the optical component comprises a superhydrophobic surface structure. It may be said that at least part of the external surface of the optical component comprises hierarchical micro-nanostructures.

The optical sub-system may comprise a pupil expander or optical replicator, arranged to expand the exit pupil of the display. In particular, the pupil expander may be arranged to output the spatially modulated wavefront and at least one replica thereof.

The optical component of the optical sub-system may comprise a waveguide. The waveguide may be configured to expand the exit pupil of the display. The waveguide comprises an output surface arranged to output the spatially modulated light. It may be said that the spatially modulated light comprises a spatially modulated wavefront. The spatially modulated wavefront may include at least one replica of the spatially modulated light (or wavefront) formed by the spatial light modulator. The head-up display is arranged, in use, so that the spatially modulated light or wavefront is directly or indirectly directed or relayed towards the eye-box.

The head-up display may be arranged so that the output surface of the optical component (e.g. waveguide) is an external surface, and consequently exposed to ambient conditions, in situ. For example, in the case of a head-up display for a vehicle, the spatial light modulator and optical sub-system may be contained within a housing beneath the vehicle dashboard. The output surface of the optical component (e.g. waveguide) may be arranged at an aperture in the housing, thus providing an optically transparent window for the propagation of spatially modulated light to an optical combiner, such as the vehicle windscreen. In this case, the output surface of the optical component is an external surface, which may be exposed to different ambient conditions beneath the dashboard, such as high humidity, dust and other particulate contaminants. This may lead to unwanted surface contaminants, in particular deposits of liquid and particles on the external surface of the optical component, which may adversely affect image quality at the eye-box.

According to the present disclosure, at least part of the external surface of the optical component (e.g. waveguide) is provided with a superhydrophobic surface structure to prevent the build-up of (liquid and solid) surface contaminants thereon. Superhydrophobic surface structures are known for providing self-cleaning properties to a surface exposed to moisture and other contaminants. In particular, a superhydrophobic surface structure comprises so-called “hierarchical micro-nanostructures”. Typically, the hierarchical micro-nanostructures comprise an array of surface structures having a three-dimensional micro-nanostructure template shape such as a micro-pillar having a plurality of hair-like nanofeatures arranged thereon. The shape of the micro-nanostructure template is arranged to provide a large contact angle so that liquid coming into contact with, or condensing on, the surface forms spherical droplets. Thus, liquid droplets may roll off a superhydrophobic surface structure and, in the process, collect particles, such as dust and other contaminants.

Superhydrophobic structures are not conventionally used on the surfaces of optical components in applications, such as displays and image capture applications, in which light propagates through the surface and carries information, such as image content, which needs to be preserved. In particular, it is understood that the formation of an arrangement of three-dimensional hierarchical micro-nanostructures on the surface would have the effect of modifying the wavefront of light propagating through the surface, and thus change (e.g., distort) the image content to be displayed or captured. In the case of spatially modulated light comprising a holographic wavefront, the optical effects of the superhydrophobic surface structure on the wavefront may be even more complex, with the potential that a holographic reconstruction may not even resemble the target image. Thus, there is a prejudice in the art of displays and image capture against the use of superhydrophobic structures to provide self-cleaning properties on surfaces of optical components. However, the inventor realised that the problem of changes/distortions due to superhydrophobic structures on the surface of an optical component may be addressed in holographic display applications by pre-compensating for the presence of the superhydrophobic surface structure when determining the hologram of the image (in other words, the picture). It may be said that the hologram may be encoded to pre-compensate for the effects of the superhydrophobic surface structure. In particular, the inventor realised that pre-compensation techniques for hologram determination are possible due to the regular, periodic nature, and predefined shape, of the hierarchical micro-nanostructures of the superhydrophobic surface structure. As a result of these recognitions, the present invention provides at least part of an external surface of an optical component of an optical sub-system (or optical relay) of a head-up display with a superhydrophobic surface structure, in particular hierarchical micro-nanostructures. The head-up display may be a holographic head-up display. In this way, the external surface of the optical component has self-cleaning properties.

In some embodiments, the optical component (e.g. waveguide) comprises a reflection suppression device. In particular, the external surface of the optical component may be exposed to sunlight. In consequence, the external surface of the optical component may be susceptible to cause glare, by reflecting sunlight onto an optical path to a viewer at the eye-box. This could be distracting and uncomfortable for the viewer. Thus, a reflection suppression device is provided at the external surface of the optical component (e.g. waveguide) to reduce said glare. It may be said that the reflection suppression device is a glare mitigation component. Accordingly, the superhydrophobic surface structure (or hierarchical micro-nanostructures) may be formed on an external surface of the reflection suppression device of the optical component (e.g. waveguide). The reflection suppression device may take any suitable form, which allows the propagation of a spatially modulated wavefront through it surface, whilst preventing unwanted reflections of sunlight towards the eye-box.

In some embodiments, the superhydrophobic surface structure/hierarchical micro-nanostructures comprises a layer on the external surface of the optical component. The layer may comprise an optically transparent material, such as polymer, thermoplastic (e.g. polycarbonate) or glass. In some examples, the layer is separate from the optical component. For instance, the layer may be manufactured separately (e.g. from a sheet formed by injection moulding, hot embossing or casting or by laser ablation of the surface of a sheet of material), as a cover or complementary insert to overlie the external surface of the optical component. The material of the layer may be matched to the material of the optical component. In particular, the superhydrophobic surface structure/micro-nanostructure layer may be formed of the same material as the optical component or a material that is refractive index matched to the material of the optical component. In other examples, the layer may be integrally formed with the optical component or a part thereof (e.g. a reflection suppression device). In this case, the design of the optical component, or associated parts or layers thereof, may incorporate the shape and configuration of the superhydrophobic surface structure/hierarchical micro-nanostructures at its external surface.

In some embodiments, a drainage channel may be provided. The drainage channel may comprise a channel-shaped recess. The drainage channel may be positioned adjacent at least one edge of the optical component. The drainage channel may be arranged to collect liquid and associated particles and contaminants received from the hierarchical micro-nanostructure.

In some implementations, the optical sub-system is configured so that, in use, the optical component is tilted from a horizontal plane. The drainage channel is positioned adjacent at least one lowest edge face of the tilted optical component. In this way, liquid droplets formed on the external surface of the optical component roll off the surface to the drainage channel due to gravity. In some embodiments, the drainage channel may include an outlet for the collection of liquid and particulate contaminants.

The head-up display may further comprise a light source. The light source may be a coherent light source, such as a laser. The light source may be arranged to illuminate the spatial light modulator. The spatial light modulator may be a pixelated spatial light modulator, such as a liquid crystal on silicon (LCOS) spatial light modulator. The head-up display may be arranged such that a hologram is displayed on the spatial light modulator. It may be said that the head-up display is a holographic head-up display. The light source may be arranged to illuminate the spatial light modulator so that light is spatially modulated in accordance with the hologram. This may form a holographic wavefront. The head-up display may be further arranged such that the holographic wavefront is received by the optical sub-system.

Some embodiments comprise a holographic head-up display, in which the spatial light modulator is arranged to display a hologram of an image (i.e. a target image). The hologram displayed on the spatial light modulator may pre-compensate for the optical effects of the superhydrophobic surface structure/hierarchical micro-nanostructures. In particular, in embodiments, a hologram of the image to be displayed may be determined to modify/pre-compensate the holographic wavefront output by the spatial light modulator so as to correct for optical effects on the holographic wavefront output by the optical component due to the presence of the superhydrophobic surface structure/hierarchical micro-nanostructures at the external surface thereof. Thus, a faithful, undistorted representation of the image is perceived by a viewer at the eye-box. It is possible to apply such pre-compensation during hologram calculation by virtue of the regular, periodic nature, and well-defined shape, of the superhydrophobic surface structure/or hierarchical micro-nanostructures).

An optical component for a head-up display is provided. At least a part of an external surface, such as an output surface, of the optical component comprises a superhydrophobic surface structure, such as hierarchical micro-nanostructures. In embodiments, the optical component comprises a waveguide having a reflection suppression device arranged adjacent an output surface thereof. The reflection suppression device comprises the external surface of the optical component.

A cover or insert for an optical component of a head-up display is provided. The cover or insert comprises a superhydrophobic surface structure layer having a complementary configuration to the external surface of the optical component, such as a surface of a reflection suppression device.

Features and advantages described in relation to one aspect may be applicable to other aspects.

In the present disclosure, the term “replica” is merely used to reflect that spatially modulated light is divided such that a complex light field is directed along a plurality of different optical paths. The word “replica” is used to refer to each occurrence or instance of the complex light field after a replication event—such as a partial reflection-transmission by a pupil expander. Each replica travels along a different optical path. Some embodiments of the present disclosure relate to propagation of light that is encoded with a hologram, not an image—i.e., light that is spatially modulated with a hologram of an image, not the image itself. It may therefore be said that a plurality of replicas of the hologram are formed. The person skilled in the art of holography will appreciate that the complex light field associated with propagation of light encoded with a hologram will change with propagation distance. Use herein of the term “replica” is independent of propagation distance and so the two branches or paths of light associated with a replication event are still referred to as “replicas” of each other even if the branches are a different length, such that the complex light field has evolved differently along each path. That is, two complex light fields are still considered “replicas” in accordance with this disclosure even if they are associated with different propagation distances—providing they have arisen from the same replication event or series of replication events.

A “diffracted light field” or “diffractive light field” in accordance with this disclosure is a light field formed by diffraction. A diffracted light field may be formed by illuminating a corresponding diffractive pattern. In accordance with this disclosure, an example of a diffractive pattern is a hologram and an example of a diffracted light field is a holographic light field or a light field forming a holographic reconstruction of an image. The holographic light field forms a (holographic) reconstruction of an image on a replay plane. The holographic light field that propagates from the hologram to the replay plane may be said to comprise light encoded with the hologram or light in the hologram domain. A diffracted light field is characterized by a diffraction angle determined by the smallest feature size of the diffractive structure and the wavelength of the light (of the diffracted light field). In accordance with this disclosure, it may also be said that a “diffracted light field” is a light field that forms a reconstruction on a plane spatially separated from the corresponding diffractive structure. An optical system is disclosed herein for propagating a diffracted light field from a diffractive structure to a viewer. The diffracted light field may form an image.

The term “hologram” is used to refer to the recording which contains amplitude information or phase information, or some combination thereof, regarding the object. The term “holographic reconstruction” is used to refer to the optical reconstruction of the object which is formed by illuminating the hologram. The system disclosed herein is described as a “holographic projector” because the holographic reconstruction is a real image and spatially-separated from the hologram. The term “replay field” is used to refer to the 2D area within which the holographic reconstruction is formed and fully focused. If the hologram is displayed on a spatial light modulator comprising pixels, the replay field will be repeated in the form of a plurality diffracted orders wherein each diffracted order is a replica of the zeroth-order replay field. The zeroth-order replay field generally corresponds to the preferred or primary replay field because it is the brightest replay field. Unless explicitly stated otherwise, the term “replay field” should be taken as referring to the zeroth-order replay field. The term “replay plane” is used to refer to the plane in space containing all the replay fields. The terms “image”, “replay image” and “image region” refer to areas of the replay field illuminated by light of the holographic reconstruction. In some embodiments, the “image” may comprise discrete spots which may be referred to as “image spots” or, for convenience only, “image pixels”.

The terms “encoding”, “writing” or “addressing” are used to describe the process of providing the plurality of pixels of the SLM with a respective plurality of control values which respectively determine the modulation level of each pixel. It may be said that the pixels of the SLM are configured to “display” a light modulation distribution in response to receiving the plurality of control values. Thus, the SLM may be said to “display” a hologram and the hologram may be considered an array of light modulation values or levels.

It has been found that a holographic reconstruction of acceptable quality can be formed from a “hologram” containing only phase information related to the Fourier transform of the original object. Such a holographic recording may be referred to as a phase-only hologram. Embodiments relate to a phase-only hologram but the present disclosure is equally applicable to amplitude-only holography.

The present disclosure is also equally applicable to forming a holographic reconstruction using amplitude and phase information related to the Fourier transform of the original object. In some embodiments, this is achieved by complex modulation using a so-called fully complex hologram which contains both amplitude and phase information related to the original object. Such a hologram may be referred to as a fully-complex hologram because the value (grey level) assigned to each pixel of the hologram has an amplitude and phase component. The value (grey level) assigned to each pixel may be represented as a complex number having both amplitude and phase components. In some embodiments, a fully-complex computer-generated hologram is calculated.

Reference may be made to the phase value, phase component, phase information or, simply, phase of pixels of the computer-generated hologram or the spatial light modulator as shorthand for “phase-delay”. That is, any phase value described is, in fact, a number (e.g. in the range 0 to 2π) which represents the amount of phase retardation provided by that pixel. For example, a pixel of the spatial light modulator described as having a phase value of π/2 will retard the phase of received light by π/2 radians. In some embodiments, each pixel of the spatial light modulator is operable in one of a plurality of possible modulation values (e.g. phase delay values). The term “grey level” may be used to refer to the plurality of available modulation levels. For example, the term “grey level” may be used for convenience to refer to the plurality of available phase levels in a phase-only modulator even though different phase levels do not provide different shades of grey. The term “grey level” may also be used for convenience to refer to the plurality of available complex modulation levels in a complex modulator.

The hologram therefore comprises an array of grey levels—that is, an array of light modulation values such as an array of phase-delay values or complex modulation values. The hologram is also considered a diffractive pattern because it is a pattern that causes diffraction when displayed on a spatial light modulator and illuminated with light having a wavelength comparable to, generally less than, the pixel pitch of the spatial light modulator. Reference is made herein to combining the hologram with other diffractive patterns such as diffractive patterns functioning as a lens or grating. For example, a diffractive pattern functioning as a grating may be combined with a hologram to translate the replay field on the replay plane or a diffractive pattern functioning as a lens may be combined with a hologram to focus the holographic reconstruction on a replay plane in the near field.

Although different embodiments and groups of embodiments may be disclosed separately in the detailed description which follows, any feature of any embodiment or group of embodiments may be combined with any other feature or combination of features of any embodiment or group of embodiments. That is, all possible combinations and permutations of features disclosed in the present disclosure are envisaged.

### BRIEF DESCRIPTION OF THE DRAWINGS

Specific embodiments are described by way of example only with reference to the following figures:

FIG. 1 is a schematic showing a reflective SLM producing a holographic reconstruction on a screen;

FIG. 2 shows an image for projection comprising eight image areas/components, V1 to V8, and cross-sections of the corresponding hologram channels, H1-H8;

FIG. 3 shows a hologram displayed on an LCOS that directs light into a plurality of discrete areas;

FIG. 4 shows a system, including a display device that displays a hologram that has been calculated as illustrated in FIGS. 2 and 3;

FIGS. 5A and 5B show perspective views of a first example two-dimensional pupil expander comprising two replicators;

FIGS. 6A and 6B are schematic views of an automotive head-up display system showing potential areas of sunlight glare;

FIG. 7 is a schematic side view of a first reflection suppression device for a waveguide according to an embodiment of the disclosure in combination with a turning layer;

FIG. 8 is a schematic perspective view of the first reflection suppression device of FIG. 7;

FIG. 9 is a schematic perspective view of an example arrangement of an optical component comprising the reflection suppression device of FIG. 7 with a self-cleaning output surface according to the present disclosure;

FIG. 10 is an end view of the example arrangement of FIG. 9, and

FIG. 11 is a schematic cross section of an example superhydrophobic surface structure for a self-cleaning output surface of an optical component according to the present disclosure.

The same reference numbers will be used throughout the drawings to refer to the same or like parts.

### DETAILED DESCRIPTION OF EMBODIMENTS

The present invention is not restricted to the embodiments described in the following but extends to the full scope of the appended claims. That is, the present invention may be embodied in different forms and should not be construed as limited to the described embodiments, which are set out for the purpose of illustration.

Terms of a singular form may include plural forms unless specified otherwise.

A structure described as being formed at an upper portion/lower portion of another structure or on/under the other structure should be construed as including a case where the structures contact each other and, moreover, a case where a third structure is disposed there between.

In describing a time relationship—for example, when the temporal order of events is described as “after”, “subsequent”, “next”, “before” or suchlike—the present disclosure should be taken to include continuous and non-continuous events unless otherwise specified. For example, the description should be taken to include a case which is not continuous unless wording such as “just”, “immediate” or “direct” is used.

Although the terms “first”, “second”, etc. may be used herein to describe various elements, these elements are not to be limited by these terms. These terms are only used to distinguish one element from another. For example, a first element could be termed a second element, and, similarly, a second element could be termed a first element, without departing from the scope of the appended claims.

Features of different embodiments may be partially or overall coupled to or combined with each other, and may be variously inter-operated with each other. Some embodiments may be carried out independently from each other, or may be carried out together in co-dependent relationship.

In the present disclosure, the term “substantially” when applied to a structural units of an apparatus may be interpreted as the technical feature of the structural units being produced within the technical tolerance of the method used to manufacture it.

### Conventional Optical Configuration for Holographic Projection

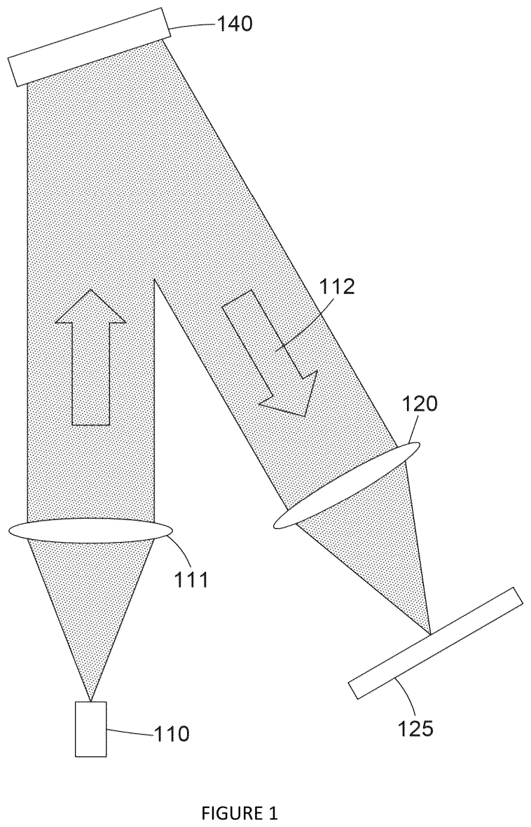

FIG. 1 shows an embodiment in which a computer-generated hologram is encoded on a single spatial light modulator. The computer-generated hologram is a Fourier transform of the object for reconstruction. It may therefore be said that the hologram is a Fourier domain or frequency domain or spectral domain representation of the object. In this embodiment, the spatial light modulator is a reflective liquid crystal on silicon, “LCOS”, device. The hologram is encoded on the spatial light modulator and a holographic reconstruction is formed at a replay field, for example, a light receiving surface such as a screen or diffuser.

A light source 110, for example a laser or laser diode, is disposed to illuminate the SLM 140 via a collimating lens 111. The collimating lens causes a generally planar wavefront of light to be incident on the SLM. In FIG. 1, the direction of the wavefront is off-normal (e.g. two or three degrees away from being truly orthogonal to the plane of the transparent layer). However, in other embodiments, the generally planar wavefront is provided at normal incidence and a beam splitter arrangement is used to separate the input and output optical paths. In the embodiment shown in FIG. 1, the arrangement is such that light from the light source is reflected off a mirrored rear surface of the SLM and interacts with a light-modulating layer to form an exit wavefront 112. The exit wavefront 112 is applied to optics including a Fourier transform lens 120, having its focus at a screen 125. More specifically, the Fourier transform lens 120 receives a beam of modulated light from the SLM 140 and performs a frequency-space transformation to produce a holographic reconstruction at the screen 125.

Notably, in this type of holography, each pixel of the hologram contributes to the whole reconstruction. There is not a one-to-one correlation between specific points (or image pixels) on the replay field and specific light-modulating elements (or hologram pixels). In other words, modulated light exiting the light-modulating layer is distributed across the replay field. In these embodiments, the position of the holographic reconstruction in space is determined by the dioptric (focusing) power of the Fourier transform lens. In the embodiment shown in FIG. 1, the Fourier transform lens is a physical lens. That is, the Fourier transform lens is an optical Fourier transform lens and the Fourier transform is performed optically. Any lens can act as a Fourier transform lens but the performance of the lens will limit the accuracy of the Fourier transform it performs. The skilled person understands how to use a lens to perform an optical Fourier transform In some embodiments of the present disclosure, the lens of the viewer's eye performs the hologram to image transformation.

### Hologram Calculation

In some embodiments, the computer-generated hologram is a Fourier transform hologram, or simply a Fourier hologram or Fourier-based hologram, in which an image is reconstructed in the far field by utilising the Fourier transforming properties of a positive lens. The Fourier hologram is calculated by Fourier transforming the desired light field in the replay plane back to the lens plane. Computer-generated Fourier holograms may be calculated using Fourier transforms. Embodiments relate to Fourier holography and Gerchberg-Saxton type algorithms by way of example only. The present disclosure is equally applicable to Fresnel holography and Fresnel holograms which may be calculated by a similar method. In some embodiments, the hologram is a phase or phase-only hologram. However, the present disclosure is also applicable to holograms calculated by other techniques such as those based on point cloud methods.

In some embodiments, the hologram engine is arranged to exclude from the hologram calculation the contribution of light blocked by a limiting aperture of the display system. British patent application 2101666.2, filed 5 Feb. 2021 and incorporated herein by reference, discloses a first hologram calculation method in which eye-tracking and ray tracing are used to identify a sub-area of the display device for calculation of a point cloud hologram which eliminates ghost images. The sub-area of the display device corresponds with the aperture, of the present disclosure, and is used exclude light paths from the hologram calculation. British patent application 2112213.0, filed 26 Aug. 2021 and incorporated herein by reference, discloses a second method based on a modified Gerchberg-Saxton type algorithm which includes steps of light field cropping in accordance with pupils of the optical system during hologram calculation. The cropping of the light field corresponds with the determination of a limiting aperture of the present disclosure. British patent application 2118911.3, filed 23 Dec. 2021 and also incorporated herein by reference, discloses a third method of calculating a hologram which includes a step of determining a region of a so-called extended modulator formed by a hologram replicator. The region of the extended modulator is also an aperture in accordance with this disclosure.

In accordance with embodiments of the present disclosure, the hologram of a target image may be pre-compensated to correct for changes (e.g. distortions) to the holographic wavefront propagating to the eye-box. In particular, the hologram engine may be arranged to determine a hologram of an image that pre-compensates for the optical effects on the holographic wavefront of a superhydrophobic surface structure of an external surface of an optical component of the optical sub-system of a head-up display. Examples of techniques for optical pre-compensation in hologram calculation are known in the art (see, e.g., European patent 2936252 incorporated herein by reference).

In some embodiments, there is provided a real-time engine arranged to receive image data and calculate holograms in real-time using the algorithm. In some embodiments, the image data is a video comprising a sequence of image frames. In other embodiments, the holograms are pre-calculated, stored in computer memory and recalled as needed for display on a SLM. That is, in some embodiments, there is provided a repository of predetermined holograms.

### Large Field of View and Eye-Box Using Small Display Device

Broadly, the present disclosure relates to image projection. It relates to a method of image projection and an image projector which comprises a display device. The present disclosure also relates to a projection system comprising the image projector and a viewing system, in which the image projector projects or relays light from the display device to the viewing system. The present disclosure is equally applicable to a monocular and binocular viewing system. The viewing system may comprise a viewer's eye or eyes. The viewing system comprises an optical element having optical power (e.g., lens/es of the human eye) and a viewing plane (e.g., retina of the human eye/s). The projector may be referred to as a ‘light engine’. The display device and the image formed (or perceived) using the display device are spatially separated from one another. The image is formed, or perceived by a viewer, on a display plane. In some embodiments, the image is a virtual image and the display plane may be referred to as a virtual image plane. In other examples, the image is a real image formed by holographic reconstruction and the image is projected or relayed to the viewing plane. In these other examples, spatially modulated light of an intermediate holographic reconstruction formed either in free space or on a screen or other light receiving surface between the display device and the viewer, is propagated to the viewer. In both cases, an image is formed by illuminating a diffractive pattern (e.g., hologram or kinoform) displayed on the display device.

The display device comprises pixels. The pixels of the display may display a diffractive pattern or structure that diffracts light. The diffracted light may form an image at a plane spatially separated from the display device. In accordance with well-understood optics, the magnitude of the maximum diffraction angle is determined by the size of the pixels and other factors such as the wavelength of the light.

In embodiments, the display device is a spatial light modulator such as liquid crystal on silicon (“LCOS”) spatial light modulator (SLM). Light propagates over a range of diffraction angles (for example, from zero to the maximum diffractive angle) from the LCOS, towards a viewing entity/system such as a camera or an eye. In some embodiments, magnification techniques may be used to increase the range of available diffraction angles beyond the conventional maximum diffraction angle of an LCOS.

In some embodiments, the (light of a) hologram itself is propagated to the eyes. For example, spatially modulated light of the hologram (that has not yet been fully transformed to a holographic reconstruction, i.e. image)—that may be informally said to be “encoded” with/by the hologram—is propagated directly to the viewer's eyes. A real or virtual image may be perceived by the viewer. In these embodiments, there is no intermediate holographic reconstruction/image formed between the display device and the viewer. It is sometimes said that, in these embodiments, the lens of the eye performs a hologram-to-image conversion or transform. The projection system, or light engine, may be configured so that the viewer effectively looks directly at the display device.

Reference is made herein to a “light field” which is a “complex light field”. The term “light field” merely indicates a pattern of light having a finite size in at least two orthogonal spatial directions, e.g. x and y. The word “complex” is used herein merely to indicate that the light at each point in the light field may be defined by an amplitude value and a phase value, and may therefore be represented by a complex number or a pair of values. For the purpose of hologram calculation, the complex light field may be a two-dimensional array of complex numbers, wherein the complex numbers define the light intensity and phase at a plurality of discrete locations within the light field.

In accordance with the principles of well-understood optics, the range of angles of light propagating from a display device that can be viewed, by an eye or other viewing entity/system, varies with the distance between the display device and the viewing entity. At a 1 metre viewing distance, for example, only a small range of angles from an LCOS can propagate through an eye's pupil to form an image at the retina for a given eye position. The range of angles of light rays that are propagated from the display device, which can successfully propagate through an eye's pupil to form an image at the retina for a given eye position, determines the portion of the image that is ‘visible’ to the viewer. In other words, not all parts of the image are visible from any one point on the viewing plane (e.g., any one eye position within a viewing window such as eye-box.)

In some embodiments, the image perceived by a viewer is a virtual image that appears upstream of the display device-that is, the viewer perceives the image as being further away from them than the display device. Conceptually, it may therefore be considered that the viewer is looking at a virtual image through an ‘display device-sized window’, which may be very small, for example 1 cm in diameter, at a relatively large distance, e.g., 1 metre. And the user will be viewing the display device-sized window via the pupil(s) of their eye(s), which can also be very small. Accordingly, the field of view becomes small and the specific angular range that can be seen depends heavily on the eye position, at any given time.

A pupil expander addresses the problem of how to increase the range of angles of light rays that are propagated from the display device that can successfully propagate through an eye's pupil to form an image. The display device is generally (in relative terms) small and the projection distance is (in relative terms) large. In some embodiments, the projection distance is at least one—such as, at least two—orders of magnitude greater than the diameter, or width, of the entrance pupil and/or aperture of the display device (i.e., size of the array of pixels).

Use of a pupil expander increases the viewing area (i.e., user's eye-box) laterally, thus enabling some movement of the eye/s to occur, whilst still enabling the user to see the image. As the skilled person will appreciate, in an imaging system, the viewing area (user's eye box) is the area in which a viewer's eyes can perceive the image. The present disclosure encompasses non-infinite virtual image distances—that is, near-field virtual images.

Conventionally, a two-dimensional pupil expander comprises one or more one-dimensional optical waveguides each formed using a pair of opposing reflective surfaces, in which the output light from a surface forms a viewing window or eye-box. Light received from the display device (e.g., spatially modulated light from a LCOS) is replicated by the or each waveguide so as to increase the field of view (or viewing area) in at least one dimension. In particular, the waveguide enlarges the viewing window due to the generation of extra rays or “replicas” by division of amplitude of the incident wavefront.

The display device may have an active or display area having a first dimension that may be less than 10 cms such as less than 5 cms or less than 2 cms. The propagation distance between the display device and viewing system may be greater than 1 m such as greater than 1.5 m or greater than 2 m. The optical propagation distance within the waveguide may be up to 2 m such as up to 1.5 m or up to 1 m. The method may be capable of receiving an image and determining a corresponding hologram of sufficient quality in less than 20 ms such as less than 15 ms or less than 10 ms.

In some embodiments—described only by way of example of a diffracted or holographic light field in accordance with this disclosure—a hologram is configured to route light into a plurality of channels, each channel corresponding to a different part (i.e. sub-area) of an image. The channels formed by the diffractive structure are referred to herein as “hologram channels” merely to reflect that they are channels of light encoded by the hologram with image information. It may be said that the light of each channel is in the hologram domain rather than the image or spatial domain. In some embodiments, the hologram is a Fourier or Fourier transform hologram and the hologram domain is therefore the Fourier or frequency domain. The hologram may equally be a Fresnel or Fresnel transform hologram. The hologram may also be a point cloud hologram. The hologram is described herein as routing light into a plurality of hologram channels to reflect that the image that can be reconstructed from the hologram has a finite size and can be arbitrarily divided into a plurality of image sub-areas, wherein each hologram channel would correspond to each image sub-area. Importantly, the hologram of this example is characterised by how it distributes the image content when illuminated. Specifically and uniquely, the hologram divides the image content by angle. That is, each point on the image is associated with a unique light ray angle in the spatially modulated light formed by the hologram when illuminated—at least, a unique pair of angles because the hologram is two-dimensional. For the avoidance of doubt, this hologram behaviour is not conventional. The spatially modulated light formed by this special type of hologram, when illuminated, may be divided into a plurality of hologram channels, wherein each hologram channel is defined by a range of light ray angles (in two-dimensions). It will be understood from the foregoing that any hologram channel (i.e. sub-range of light ray angles) that may be considered in the spatially modulated light will be associated with a respective part or sub-area of the image. That is, all the information needed to reconstruct that part or sub-area of the image is contained within a sub-range of angles of the spatially modulated light formed from the hologram of the image. When the spatially modulated light is observed as a whole, there is not necessarily any evidence of a plurality of discrete light channels.

Nevertheless, the hologram may still be identified. For example, if only a continuous part or sub-area of the spatially modulated light formed by the hologram is reconstructed, only a sub-area of the image should be visible. If a different, continuous part or sub-area of the spatially modulated light is reconstructed, a different sub-area of the image should be visible. A further identifying feature of this type of hologram is that the shape of the cross-sectional area of any hologram channel substantially corresponds to (i.e. is substantially the same as) the shape of the entrance pupil although the size may be different—at least, at the correct plane for which the hologram was calculated. Each light/hologram channel propagates from the hologram at a different angle or range of angles. Whilst these are example ways of characterising or identifying this type of hologram, other ways may be used. In summary, the hologram disclosed herein is characterised and identifiable by how the image content is distributed within light encoded by the hologram. Again, for the avoidance of any doubt, reference herein to a hologram configured to direct light or angularly-divide an image into a plurality of hologram channels is made by way of example only and the present disclosure is equally applicable to pupil expansion of any type of holographic light field or even any type of diffractive or diffracted light field.

The system can be provided in a compact and streamlined physical form. This enables the system to be suitable for a broad range of real-world applications, including those for which space is limited and real-estate value is high. For example, it may be implemented in a head-up display (HUD) such as a vehicle or automotive HUD.

In accordance with the present disclosure, pupil expansion is provided for diffracted or diffractive light, which may comprise diverging ray bundles. The diffracted light field may be defined by a “light cone”. Thus, the size of the diffracted light field (as defined on a two-dimensional plane) increases with propagation distance from the corresponding diffractive structure (i.e. display device). It can be said that the pupil expander/s replicate the hologram or form at least one replica of the hologram, to convey that the light delivered to the viewer is spatially modulated in accordance with a hologram.

In some embodiments, two one-dimensional waveguide pupil expanders are provided, each one-dimensional waveguide pupil expander being arranged to effectively increase the size of the exit pupil of the system by forming a plurality of replicas or copies of the exit pupil (or light of the exit pupil) of the spatial light modulator. The exit pupil may be understood to be the physical area from which light is output by the system. It may also be said that each waveguide pupil expander is arranged to expand the size of the exit pupil of the system. It may also be said that each waveguide pupil expander is arranged to expand/increase the size of the eye box within which a viewer's eye can be located, in order to see/receive light that is output by the system.

### Light Channelling

The hologram formed in accordance with some embodiments, angularly-divides the image content to provide a plurality of hologram channels which may have a cross-sectional shape defined by an aperture of the optical system. The hologram is calculated to provide this channelling of the diffracted light field. In some embodiments, this is achieved during hologram calculation by considering an aperture (virtual or real) of the optical system, as described above.

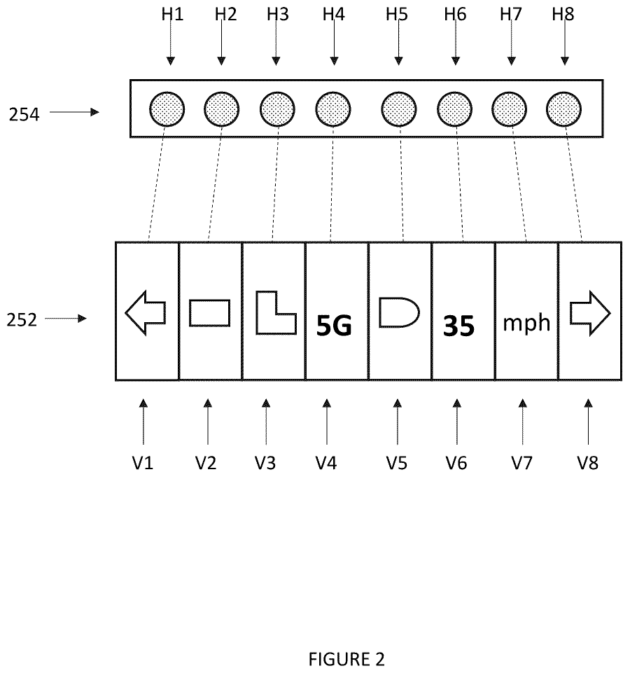

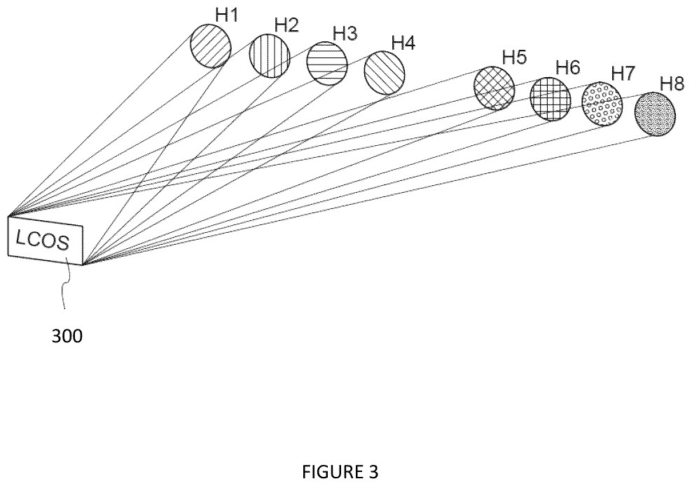

FIGS. 2 and 3 show an example of this type of hologram that may be used in conjunction with a pupil expander as disclosed herein. However, this example should not be regarded as limiting with respect to the present disclosure.

FIG. 2 shows an image 252 for projection comprising eight image areas/components, V1 to V8. FIG. 2 shows eight image components by way of example only and the image 252 may be divided into any number of components. FIG. 2 also shows an encoded light pattern 254 (i.e., hologram) that can reconstruct the image 252—e.g., when transformed by the lens of a suitable viewing system. The encoded light pattern 254 comprises first to eighth sub-holograms or components, H1 to H8, corresponding to the first to eighth image components/areas, V1 to V8. FIG. 2 further shows how a hologram may decompose the image content by angle. The hologram may therefore be characterised by the channelling of light that it performs. This is illustrated in FIG. 3. Specifically, the hologram in this example directs light into a plurality of discrete areas. The discrete areas are discs in the example shown but other shapes are envisaged. The size and shape of the optimum disc may, after propagation through the waveguide, be related to the size and shape of an aperture of the optical system such as the entrance pupil of the viewing system.

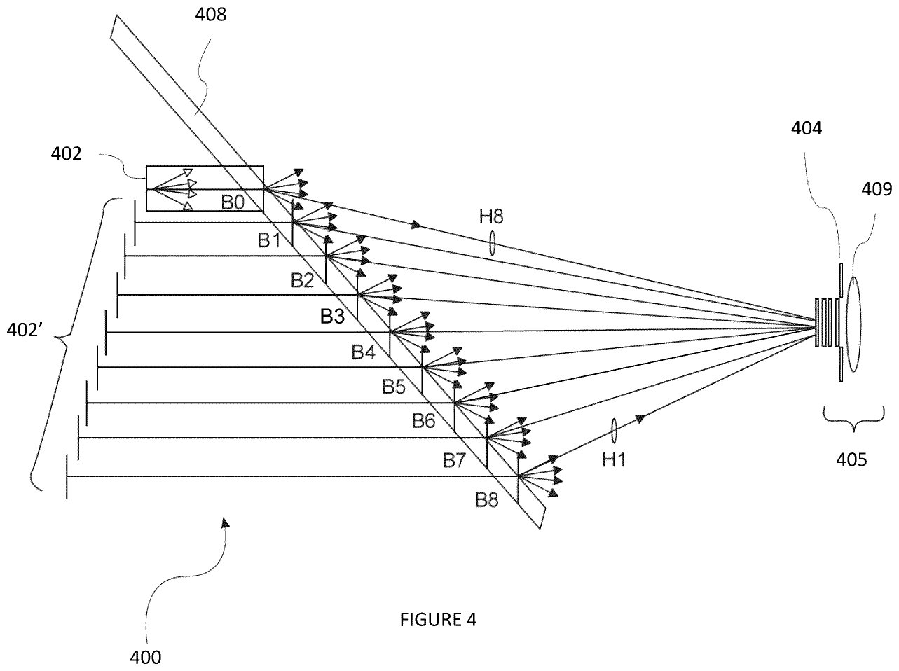

FIG. 4 shows a system 400, including a display device that displays a hologram that has been calculated as illustrated in FIGS. 2 and 3.

The system 400 comprises a display device, which in this arrangement comprises an LCOS 402. The LCOS 402 is arranged to display a modulation pattern (or ‘diffractive pattern’) comprising the hologram and to project light that has been holographically encoded towards an eye 405 that comprises a pupil that acts as an aperture 404, a lens 409, and a retina (not shown) that acts as a viewing plane. There is a light source (not shown) arranged to illuminate the LCOS 402. The lens 409 of the eye 405 performs a hologram-to-image transformation. The light source may be of any suitable type. For example, it may comprise a laser light source.

The viewing system 400 further comprises a waveguide 408 positioned between the LCOS 402 and the eye 405. The presence of the waveguide 408 enables all angular content from the LCOS 402 to be received by the eye, even at the relatively large projection distance shown. This is because the waveguide 508 acts as a pupil expander, in a manner that is well known and so is described only briefly herein.

In brief, the waveguide 408 shown in FIG. 4 comprises a substantially elongate formation. In this example, the waveguide 408 comprises an optical slab of refractive material, but other types of waveguide are also well known and may be used. The waveguide 408 is located so as to intersect the light cone (i.e., the diffracted light field) that is projected from the LCOS 402, for example at an oblique angle. In this example, the size, location, and position of the waveguide 408 are configured to ensure that light from each of the eight ray bundles, within the light cone, enters the waveguide 408. Light from the light cone enters the waveguide 408 via its first planar surface (located nearest the LCOS 402) and is guided at least partially along the length of the waveguide 408, before being emitted via its second planar surface, substantially opposite the first surface (located nearest the eye). As will be well understood, the second planar surface is partially reflective, partially transmissive. In other words, when each ray of light travels within the waveguide 408 from the first planar surface and hits the second planar surface, some of the light will be transmitted out of the waveguide 408 and some will be reflected by the second planar surface, back towards the first planar surface. The first planar surface is reflective, such that all light that hits it, from within the waveguide 408, will be reflected back towards the second planar surface. Therefore, some of the light may simply be refracted between the two planar surfaces of the waveguide 408 before being transmitted, whilst other light may be reflected, and thus may undergo one or more reflections, (or ‘bounces’) between the planar surfaces of the waveguide 408, before being transmitted.

FIG. 4 shows a total of nine “bounce” points, B0 to B8, along the length of the waveguide 408. Although light relating to all points of the image (V1-V8) as shown in FIG. 2 is transmitted out of the waveguide at each “bounce” from the second planar surface of the waveguide 408, only the light from one angular part of the image (e.g. light of one of V1 to V8) has a trajectory that enables it to reach the eye 405, from each respective “bounce” point, B0 to B8. Moreover, light from a different angular part of the image, V1 to V8, reaches the eye 405 from each respective “bounce” point. Therefore, each angular channel of encoded light reaches the eye only once, from the waveguide 408, in the example of FIG. 4.

The waveguide 408 forms a plurality of replicas of the hologram, at the respective “bounce” points B1 to B8 along its length, corresponding to the direction of pupil expansion. As shown in FIG. 4, the plurality of replicas may be extrapolated back, in a straight line, to a corresponding plurality of replica or virtual display devices 402′. This process corresponds to the step of “unfolding” an optical path within the waveguide, so that a light ray of a replica is extrapolated back to a “virtual surface” without internal reflection within the waveguide. Thus, the light of the expanded exit pupil may be considered to originate from a virtual surface (also called an “extended modulator” herein) comprising the display device 402 and the replica display devices 402′.

Although virtual images, which require the eye to transform received modulated light in order to form a perceived image, have generally been discussed herein, the methods and arrangements described herein can be applied to real images.

### Two-Dimensional Pupil Expansion

Whilst the arrangement shown in FIG. 4 includes a single waveguide that provides pupil expansion in one dimension, pupil expansion can be provided in more than one dimension, for example in two dimensions. Moreover, whilst the example in FIG. 4 uses a hologram that has been calculated to create channels of light, each corresponding to a different portion of an image, the present disclosure and the systems that are described herebelow are not limited to such a hologram type.

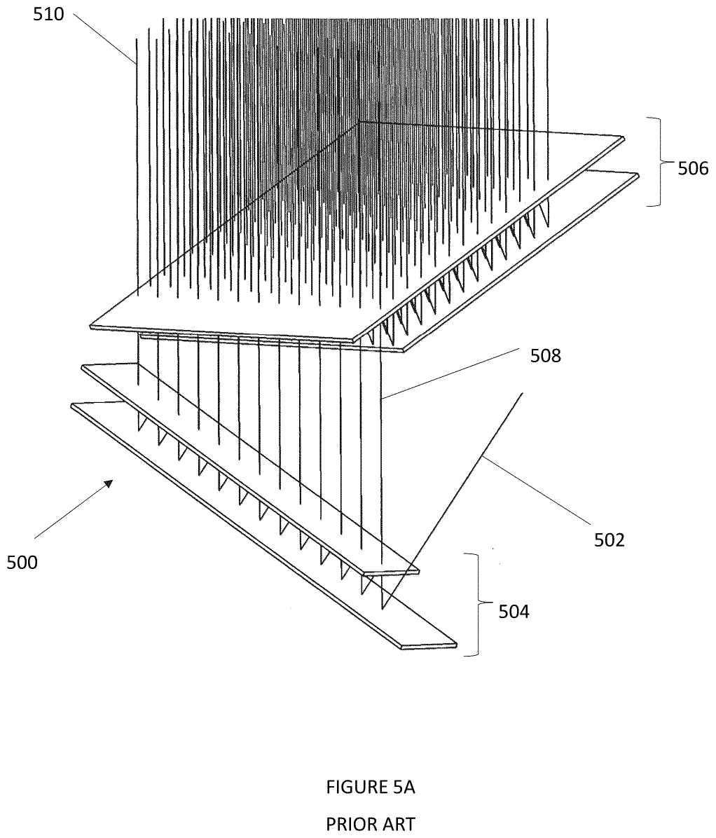

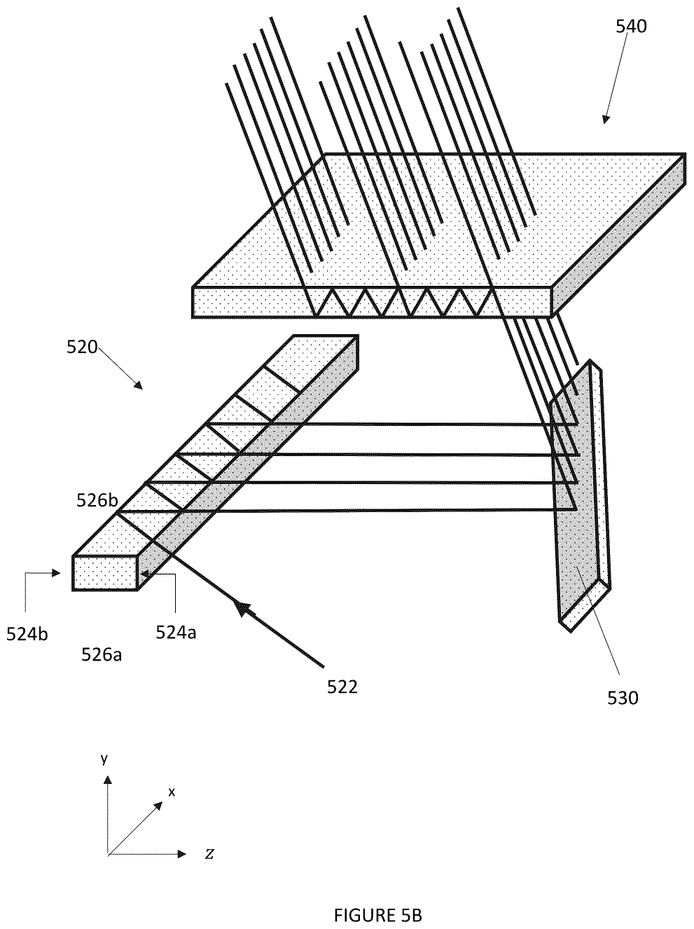

FIG. 5A shows a perspective view of a system 500 comprising two replicators, 504, 506 arranged for expanding a light beam 502 in two dimensions.

In the system 500 of FIG. 5A, the first replicator 504 comprises a first pair of surfaces, stacked parallel to one another, and arranged to provide replication—or, pupil expansion—in a similar manner to the waveguide 408 of FIG. 4. The first pair of surfaces are similarly (in some cases, identically) sized and shaped to one another and are substantially elongate in one direction. The collimated light beam 502 is directed towards an input on the first replicator 504. Due to a process of internal reflection between the two surfaces, and partial transmission of light from each of a plurality of output points on one of the surfaces (the upper surface, as shown in FIG. 5A), which will be familiar to the skilled reader, light of the light beam 502 is replicated in a first direction, along the length of the first replicator 504. Thus, a first plurality of replica light beams 508 is emitted from the first replicator 504, towards the second replicator 506.

The second replicator 506 comprises a second pair of surfaces stacked parallel to one another, arranged to receive each of the collimated light beams of the first plurality of light beams 508 and further arranged to provide replication—or, pupil expansion—by expanding each of those light beams in a second direction, substantially orthogonal to the first direction. The first pair of surfaces are similarly (in some cases, identically) sized and shaped to one another and are substantially rectangular. The rectangular shape is implemented for the second replicator in order for it to have length along the first direction, in order to receive the first plurality of light beams 508, and to have length along the second, orthogonal direction, in order to provide replication in that second direction. Due to a process of internal reflection between the two surfaces, and partial transmission of light from each of a plurality of output points on one of the surfaces (the upper surface, as shown in FIG. 5A), light of each light beam within the first plurality of light beams 508 is replicated in the second direction. Thus, a second plurality of light beams 510 is emitted from the second replicator 506, wherein the second plurality of light beams 510 comprises replicas of the input light beam 502 along each of the first direction and the second direction. Thus, the second plurality of light beams 510 may be regarded as comprising a two-dimensional grid, or array, of replica light beams.

Thus, it can be said that the first and second replicators 504, 505 of FIG. 5A combine to provide a two-dimensional replicator (or, “two-dimensional pupil expander”). Thus, the replica light beams 510 may be emitted along an optical path to an expanded eye-box of a display system, such as a head-up display.

In the system of FIG. 5A, the first replicator 504 is a waveguide comprising a pair of elongate rectilinear reflective surfaces, stacked parallel to one another, and, similarly, the second replicator 504 is a waveguide comprising a pair of rectangular reflective surfaces, stacked parallel to one another. In other systems, the first replicator may be a solid elongate rectilinear waveguide and the second replicator may be a solid planar rectangular shaped waveguide, wherein each waveguide comprises an optically transparent solid material such as glass. In this case, the pair of parallel reflective surfaces are formed by a pair of opposed major sidewalls optionally comprising respective reflective and reflective-transmissive surface coatings, familiar to the skilled reader.

FIG. 5B shows a perspective view of a system 500 comprising two replicators, 520, 540 arranged for replicating a light beam 522 in two dimensions, in which the first replicator is a solid elongated waveguide 520 and the second replicator is a solid planar waveguide 540.

In the system of FIG. 5B, the first replicator/waveguide 520 is arranged so that its pair of elongate parallel reflective surfaces 524a, 524b are perpendicular to the plane of the second replicator/waveguide 540. Accordingly, the system comprises an optical coupler arranged to couple light from an output port of first replicator 520 into an input port of the second replicator 540. In the illustrated arrangement, the optical coupler is a planar/fold mirror 530 arranged to fold or turn the optical path of light to achieve the required optical coupling from the first replicator to the second replicator. As shown in FIG. 5B, the mirror 530 is arranged to receive light—comprising a one-dimensional array of replicas extending in the first dimension—from the output port/reflective-transmissive surface 524a of the first replicator/waveguide 520. The mirror 530 is tilted so as to redirect the received light onto an optical path to an input port in the (fully) reflective surface of second replicator 540 at an angle to provide waveguiding and replica formation, along its length in the second dimension. It will be appreciated that the mirror 530 is one example of an optical element that can redirect the light in the manner shown, and that one or more other elements may be used instead, to perform this task.

In the illustrated arrangement, the (partially) reflective-transmissive surface 524a of the first replicator 520 is adjacent the input port of the first replicator/waveguide 520 that receives input beam 522 at an angle to provide waveguiding and replica formation, along its length in the first dimension. Thus, the input port of first replicator/waveguide 520 is positioned at an input end thereof at the same surface as the reflective-transmissive surface 524a. The skilled reader will understand that the input port of the first replicator/waveguide 520 may be at any other suitable position.

Accordingly, the arrangement of FIG. 5B enables the first replicator 520 and the mirror 530 to be provided as part of a first relatively thin layer in a plane in the first and third dimensions (illustrated as an x-z plane). In particular, the size or “height” of a first planar layer—in which the first replicator 520 is located-in the second dimension (illustrated as the y dimension) is reduced. The mirror 530 is configured to direct the light away from a first layer/plane, in which the first replicator 520 is located (i.e. the “first planar layer”), and direct it towards a second layer/plane, located above and substantially parallel to the first layer/plane, in which the second replicator 540 is located (i.e. a “second planar layer”). Thus, the overall size or “height” of the system—comprising the first and second replicators 520, 540 and the mirror 530 located in the stacked first and second planar layers in the first and third dimensions (illustrated as an x-z plane)—in the second dimension (illustrated as the y dimension) is compact. The skilled reader will understand that many variations of the arrangement of FIG. 5B for implementing the present disclosure are possible and contemplated.

The image projector may be arranged to project a diverging or diffracted light field. In some embodiments, the light field is encoded with a hologram. In some embodiments, the diffracted light field comprises diverging ray bundles. In some embodiments, the image formed by the diffracted light field is a virtual image.

In some embodiments, the first pair of parallel/complementary surfaces are elongate or elongated surfaces, being relatively long along a first dimension and relatively short along a second dimension, for example being relatively short along each of two other dimensions, with each dimension being substantially orthogonal to each of the respective others. The process of reflection/transmission of the light between/from the first pair of parallel surfaces is arranged to cause the light to propagate within the first waveguide pupil expander, with the general direction of light propagation being in the direction along which the first waveguide pupil expander is relatively long (i.e., in its “elongate” direction).

There is disclosed herein a system that forms an image using diffracted light and provides an eye-box size and field of view suitable for real-world application—e.g. in the automotive industry by way of a head-up display. The diffracted light is light forming a holographic reconstruction of the image from a diffractive structure—e.g. hologram such as a Fourier or Fresnel hologram. The use diffraction and a diffractive structure necessitates a display device with a high density of very small pixels (e.g. 1 micrometer)—which, in practice, means a small display device (e.g. 1 cm). The inventors have addressed a problem of how to provide 2D pupil expansion with a diffracted light field e.g. diffracted light comprising diverging (not collimated) ray bundles.

In some embodiments, the display system comprises a display device—such as a pixelated display device, for example a spatial light modulator (SLM) or Liquid Crystal on Silicon (LCoS) SLM—which is arranged to provide or form the diffracted or diverging light. In such aspects, the aperture of the spatial light modulator (SLM) is a limiting aperture of the system. That is, the aperture of the spatial light modulator—more specifically, the size of the area delimiting the array of light modulating pixels comprised within the SLM—determines the size (e.g. spatial extent) of the light ray bundle that can exit the system. In accordance with this disclosure, it is stated that the exit pupil of the system is expanded to reflect that the exit pupil of the system (that is limited by the small display device having a pixel size for light diffraction) is made larger or bigger or greater in spatial extend by the use of at least one pupil expander.

The diffracted or diverging light field may be said to have “a light field size”, defined in a direction substantially orthogonal to a propagation direction of the light field. Because the light is diffracted/diverging, the light field size increases with propagation distance.

In some embodiments, the diffracted light field is spatially-modulated in accordance with a hologram. In other words, in such aspects, the diffractive light field comprises a “holographic light field”. The hologram may be displayed on a pixelated display device. The hologram may be a computer-generated hologram (CGH). It may be a Fourier hologram or a Fresnel hologram or a point-cloud hologram or any other suitable type of hologram. The hologram may, optionally, be calculated so as to form channels of hologram light, with each channel corresponding to a different respective portion of an image that is intended to be viewed (or perceived, if it is a virtual image) by the viewer. The pixelated display device may be configured to display a plurality of different holograms, in succession or in sequence. Each of the aspects and embodiments disclosed herein may be applied to the display of multiple holograms.

The output port of the first waveguide pupil expander may be coupled to an input port of a second waveguide pupil expander. The second waveguide pupil expander may be arranged to guide the diffracted light field—including some of, preferably most of, preferably all of, the replicas of the light field that are output by the first waveguide pupil expander—from its input port to a respective output port by internal reflection between a third pair of parallel surfaces of the second waveguide pupil expander.

The first waveguide pupil expander may be arranged to provide pupil expansion, or replication, in a first direction and the second waveguide pupil expander may be arranged to provide pupil expansion, or replication, in a second, different direction. The second direction may be substantially orthogonal to the first direction. The second waveguide pupil expander may be arranged to preserve the pupil expansion that the first waveguide pupil expander has provided in the first direction and to expand (or, replicate) some of, preferably most of, preferably all of, the replicas that it receives from the first waveguide pupil expander in the second, different direction. The second waveguide pupil expander may be arranged to receive the light field directly or indirectly from the first waveguide pupil expander. One or more other elements may be provided along the propagation path of the light field between the first and second waveguide pupil expanders.

The first waveguide pupil expander may be substantially elongated and the second waveguide pupil expander may be substantially planar. The elongated shape of the first waveguide pupil expander may be defined by a length along a first dimension. The planar, or rectangular, shape of the second waveguide pupil expander may be defined by a length along a first dimension and a width, or breadth, along a second dimension substantially orthogonal to the first dimension. A size, or length, of the first waveguide pupil expander along its first dimension make correspond to the length or width of the second waveguide pupil expander along its first or second dimension, respectively. A first surface of the pair of parallel surfaces of the second waveguide pupil expander, which comprises its input port, may be shaped, sized, and/or located so as to correspond to an area defined by the output port on the first surface of the pair of parallel surfaces on the first waveguide pupil expander, such that the second waveguide pupil expander is arranged to receive each of the replicas output by the first waveguide pupil expander.

The first and second waveguide pupil expander may collectively provide pupil expansion in a first direction and in a second direction perpendicular to the first direction, optionally, wherein a plane containing the first and second directions is substantially parallel to a plane of the second waveguide pupil expander. In other words, the first and second dimensions that respectively define the length and breadth of the second waveguide pupil expander may be parallel to the first and second directions, respectively, (or to the second and first directions, respectively) in which the waveguide pupil expanders provide pupil expansion. The combination of the first waveguide pupil expander and the second waveguide pupil expander may be generally referred to as being a “pupil expander”.

It may be said that the expansion/replication provided by the first and second waveguide expanders has the effect of expanding an exit pupil of the display system in each of two directions. An area defined by the expanded exit pupil may, in turn define an expanded eye-box area, from which the viewer can receive light of the input diffracted or diverging light field. The eye-box area may be said to be located on, or to define, a viewing plane.

The two directions in which the exit pupil is expanded may be coplanar with, or parallel to, the first and second directions in which the first and second waveguide pupil expanders provide replication/expansion. Alternatively, in arrangements that comprise other elements such as an optical combiner, for example the windscreen (or, windshield) of a vehicle, the exit pupil may be regarded as being an exit pupil from that other element, such as from the windscreen. In such arrangements, the exit pupil may be non-coplanar and non-parallel with the first and second directions in which the first and second waveguide pupil expanders provide replication/expansion. For example, the exit pupil may be substantially perpendicular to the first and second directions in which the first and second waveguide pupil expanders provide replication/expansion.

The viewing plane, and/or the eye-box area, may be non-coplanar or non-parallel to the first and second directions in which the first and second waveguide pupil expanders provide replication/expansion. For example, a viewing plane may be substantially perpendicular to the first and second directions in which the first and second waveguide pupil expanders provide replication/expansion.

In order to provide suitable launch conditions to achieve internal reflection within the first and second waveguide pupil expanders, an elongate dimension of the first waveguide pupil expander may be tilted relative to the first and second dimensions of the second waveguide pupil expander.

### Combiner Shape Compensation

An advantage of projecting a hologram to the eye-box is that optical compensation can be encoded in the hologram (see, for example, European patent 2936252 incorporated herein by herein). The present disclosure is compatible with holograms that compensate for the complex curvature of an optical combiner used as part of the projection system. In some embodiments, the optical combiner is the windscreen of a vehicle. Full details of this approach are provided in European patent 2936252 and are not repeated here because the detailed features of those systems and methods are not essential to the new teaching of this disclosure herein and are merely exemplary of configurations that benefit from the teachings of the present disclosure.

### Control Device

The present disclosure is also compatible with optical configurations that include a control device (e.g. light shuttering device) to control the delivery of light from a light channelling hologram to the viewer. The holographic projector may further comprise a control device arranged to control the delivery of angular channels to the eye-box position. British patent application 2108456.1, filed 14 Jun. 2021 and incorporated herein by reference, discloses the at least one waveguide pupil expander and control device. The reader will understand from at least this prior disclosure that the optical configuration of the control device is fundamentally based upon the eye-box position of the user and is compatible with any hologram calculation method that achieves the light channeling described herein. It may be said that the control device is a light shuttering or aperturing device. The light shuttering device may comprise a 1D array of apertures or windows, wherein each aperture or window independently switchable between a light transmissive and a light non-transmissive state in order to control the delivery of hologram light channels, and their replicas, to the eye-box. Each aperture or window may comprise a plurality of liquid crystal cells or pixels.

### Reflection Suppression to Mitigate Glare

In operation, the transmission/exit surface (i.e. expanded exit pupil) of the second replicator 506 of the two-dimensional pupil expander of FIG. 5 forms an external surface or “output port” from which image light is transmitted through air to an eye-box area for viewing. Accordingly, the transmission surface may be exposed to sunlight from the environment in which the head-up display is used. Received sunlight may cause glare to the viewer, in particular due to reflections of sunlight associated with the pupil expander 506 and/or a turning film, if used in conjunction with the pupil expander 506. For example, glare may arise if rays of sunlight are directly reflected from the external transmission surface, or other surfaces of the pupil expander 506, at angles such that rays of sunlight follow an optical path directly to the viewing area/eye-box. This is described herein as “direct glare”. In another example, glare may arise if sunlight is coupled into the pupil expander 506 at angles such that rays of sunlight follow the same optical path within the pupil expander as rays of image light, or are otherwise reflected by surfaces thereof, in order to reach the viewing area/eye-box indirectly (e.g. via an optical combiner, such as a vehicle windscreen). This is described herein as “veiling glare”.

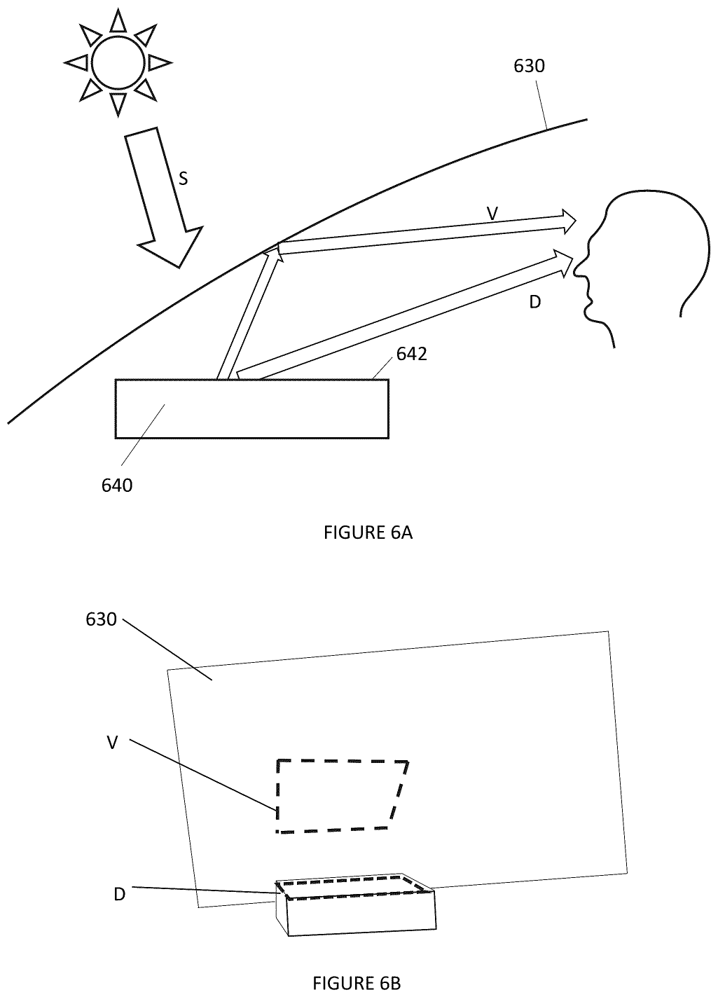

FIG. 6A shows the optical path of rays of sunlight S incident on the transmission/exit surface 642 of a (bulk optic) waveguide pupil expander 640 of a head-up display (HUD) in an automotive application. In particular, sunlight S at a relatively high elevation angle to the horizon is incident through a vehicle windscreen 630 onto the external transmission/exit surface 642 of the pupil expander 640. In the example, the transmission/exit surface 642 is located in a substantially horizontal plane in an aperture in the vehicle dashboard (not shown). Some sunlight rays D may be directly reflected from the pupil expander 640 (e.g. by one or more reflective layers thereof) towards the viewing area/eye-box and cause “direct glare”. Some other light rays V may be indirectly reflected from the pupil expander 640 (e.g. by one or more reflective layers thereof) towards the viewing area/eye box, via the windscreen 730 and cause “veiling glare”. Thus, light rays V may follow the same optical path(s) as image light output from the pupil expander 640. In either case, the glare arising from reflected sunlight may be harmful to the viewer/driver. FIG. 6B shows the view at the viewing area/eye-box indicating the areas of the windscreen and dashboard, from which the viewer/driver may receive sunlight glare. An area of direct glare D is seen at the exit/transmission surface in the vehicle dashboard (not shown) and an area of viewing glare V is seen at the vehicle windscreen. The skilled person will appreciate that the presence of glare from different positions within the illustrated areas D and V at a particular point in time may depend on the elevation angle of the sun and the configuration of the display system (both internally and in situ).

### Reflection Suppression Device

Accordingly, there is a reflection suppression device to be positioned over the transmission surface of the second replicator/pupil expander, or more generally the output port of the HUD or any other optical component comprising a reflective surface, to reduce the risk of glare to the viewer. The reflection suppression device comprises a louvre structure comprising a plurality of parallel louvres comprising a light absorbing material. The orientation (e.g. the side-wall angle(s), pitch and geometry (e.g. length, width and thickness)) of the louvres is chosen to allow image light to be transmitted from the HUD at the desired range of angles necessary to reach the viewing area/eye-box. The inventors have recognized that an array of louvres, typically in the form of longitudinal rectangular-shaped louvre slats, may be used to control the direction and/or suppress reflections of sunlight that may be incident on the transmission surface/output port of the HUD due to its upwardly facing/horizontal orientation in a vehicle dashboard adjacent the vehicle windscreen. The reflection suppression device further comprises a transparent support structure configured to provide mechanical strength and rigidity to the reflection suppression device. In particular, the support structure may be configured to substantially prevent deformation of the array louvres which would otherwise cause the louvres to deviate from the desired angle. The inventors have identified that one problem with the inclusion of the transparent structure is that sunlight (or other unwanted light) may be reflected by a surface of the transparent support structure. So, the transparent structure may introduce another source of glare into the optical system. The transparent support structure can be shaped so as to form a serrated top (or external) surface, the serrations of the serrated surface being co-ordinated with the louvres. Each of the serrations forms an angled surface. The angle of the angled surface is chosen so that light that is reflected by the angled top surface in such a way that the reflected light is not relayed to the eye-box. Thus, the serrated surface of the transparent structure acts to suppress glare as well as to improve mechanical stability.

### Head-Up Display Comprising a Reflection Suppression Device

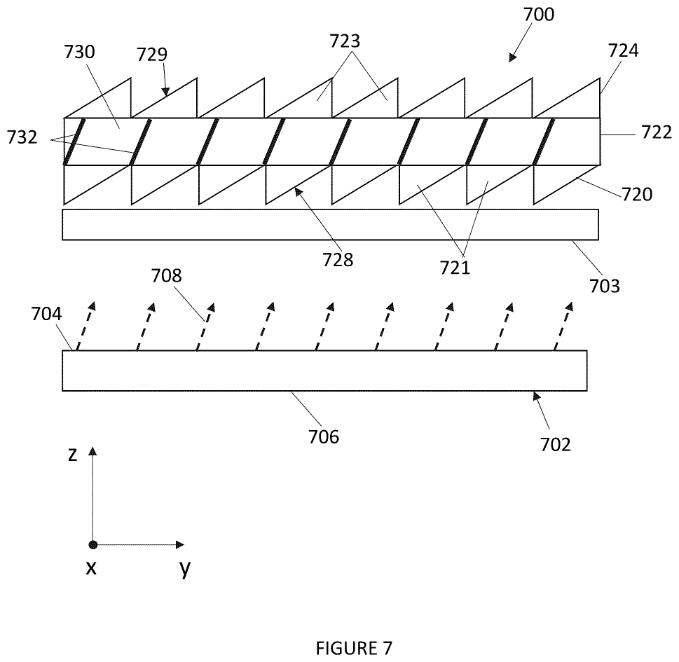

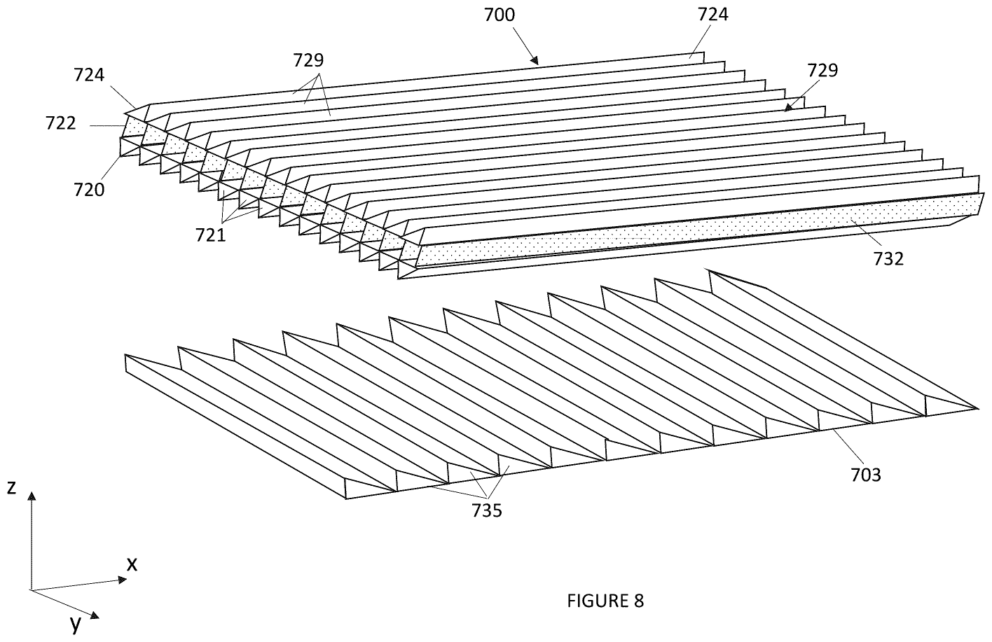

FIG. 7 shows a schematic side-view of a features of a head-up display comprising an example reflection suppression device 700. The head-up display of FIG. 7 comprises a waveguide 702, a light turning layer 703, and the reflection suppression device 700. The head-up display further comprises a coherent light source (in this example, a laser) and a display device (in this example, a liquid crystal on silicon spatial light modulator) arranged to display a hologram of a picture. The light source and display device are not shown in FIG. 7. In use, the light source of the head-up display illuminates the display device such that light is spatially modulated in accordance with the hologram displayed on the display device, thus forming a holographic wavefront. The holographic wavefront is coupled into a first waveguide (not shown in FIG. 7) where the holographic wavefront is replicated in a first direction a plurality of times (as described previously) to form a one dimensional array of replicas which are then coupled into the waveguide 702 (which is shown in FIG. 7). The waveguide 702 comprises a pair of opposing surfaces. A first surface 704 of the waveguide 702 is partially transmissive-reflective. A second surface 706 of the waveguide 708 is reflective. The waveguide 702 is arranged to waveguide the replicas of the holographic wavefront coupled in to the waveguide 702 from the first waveguide between the pair of opposing surfaces. In this way, the holographic wavefront is replicated in a second direction (that is orthogonal to the first direction) a plurality of times (again, as described previously) to form a two dimensional array of replicas. The emission of replicas from the first surface 704 is represented by the dotted arrows 708 in FIG. 7. In the y-z plane, the replicas 708 are angled with respect to a normal of the waveguide 702 (i.e. the replicas are angled with respect to the z-direction in the y-z plane). In this example, the replicas 708 of the holographic wavefront (at the first surface of the waveguide 704) do not have a component on the x-z plane. So, as the skilled reader will appreciate, in a side view of the waveguide 702 in the x-z plane, the replicas 708 would appear to be emitted vertically up the page.

The replicas 708 of the holographic wavefront emitted by the waveguide 702 are received by the turning layer 703 whereby the (replicas of) the holographic wavefront are turned by the turning layer 703. The turned replicas 708 are then received by the reflection suppression device 700. The reflection suppression device 700 comprises a layered structure which comprises a first layer 720, an intermediate layer 722, and a second layer 724. The first layer 720 is closest to the waveguide 708/turning layer 703. As such, the (replicas of) holographic wavefront (propagating through the reflection suppression device 700) are received in turn by the first layer 720, the intermediate layer 722 and the second layer 724.

The reflection suppression device 700 is used in combination with the turning layer 703 as follows.

The first (bottom/inner) layer 720 comprises a first serrated surface 728. An opposing face of the first layer 720 is a non-serrated (planar) surface. The non-serrated surface of the first layer 720 is in contact with, and adhered to, a surface of the intermediate layer 722.

The first layer 720 is a prismatic structure comprising a plurality/an array of prism elements 721. The first layer 720 is integrally formed such that the array of prism elements 721 form a single component (forming the first layer 720). The first serrated surface 728 is defined by first angled surface of each of the prism elements 721, thus forming a sawtooth-type structure when viewed in the y-z plane (as in FIG. 7, for example). The first layer 720 is formed of a transparent material which, in this example, is a hard plastic (transparent) material. The first layer 720 may have been manufactured by, for example, injection moulding, hot embossing, extruding or cutting a source of the transparent material.

The intermediate layer 722 comprises a transparent material 730 separating an array of individual louvres 732. Each louvre 732 is in the form of a slat, the length of which extends substantially in the x-direction. The louvres 732 are embedded in the transparent material 730. In this example, the transparent material 730 is a material having the same refractive index as the material forming the first layer 720.

The second (top/external) layer 724 comprises a second serrated surface 729. An opposing face of the second layer 724 is a non-serrated (planar) surface. The non-serrated surface of the second layer 724 is in contact with, and adhered to, an opposite surface of the intermediate layer 722 to the non-serrated surface of the first layer 720.

The second layer 724 is a prismatic structure comprising a plurality/an array of prism elements 723. Like the first layer 720, the second layer 724 is integrally formed such that the array of prism elements 723 form a single component (forming the first layer 722). The second serrated surface 729 is defined by first angled surfaces of each of the prism elements 723, thus forming a sawtooth-type structure when viewed in the y-z plane (as in FIG. 7, for example). The second layer 724 is formed of a transparent material which, in this example, is a hard plastic (transparent) material. In this example, the second layer 724 is formed of the transparent material as the first layer 720 (or, at least, a material having the same refractive index as the transparent material of the first layer 720). The second layer 724 may have been manufactured by, for example, injection moulding, hot embossing, extruding or cutting a source of the transparent material.

A periodicity of the serrations of the first and second serrated surfaces 728, 729 is equal. Furthermore, the periodicity of the louvres 732 in the array of louvres is equal to the periodicity of the serrations of the first and second serrated surfaces. Thus, for each serration of the first serrated surface 728 of the first layer there is a corresponding serration of the second serrated surface 729 of the second layer and a corresponding louvre 732.

The first and second layers 720, 724 have a thickness in the z-direction. This thickness is defined between the respective serrated surface and non-serrated surface. As is clear from FIG. 7 the thickness of the first and second layers varies along the length of each serration (in the y-direction) because of the angled surfaces of each microstructure. The serrations of the first layer are angled in magnitude but opposite in direction to the serration of the second layer. Specifically, an angle a normal of each angled first surface of the first serrated surface 728 to a normal of the waveguide is, in this example, equal in magnitude but opposite in polarity to an angle between each angled first surface of the second serrated surface 729 to a normal of the waveguide.

Each of the first and second layers 720, 724 are formed of a transparent material which, in this example, has a refractive index greater than 1. Each of the first and second serrated surfaces 728, 729 form a transparent material/air interface. Light (in particular, the holographic wavefront 708) propagating through reflections suppression device will be turned, twice. A first turn will be provided by the first layer 720 and a second turn will be provided by the second layer 724. The shape of the serrations, and the refractive index of the transparent material, are selected such that the component of the first turn on the first plane (the y-z plane) is equal but opposite to the component of the second turn on the first plane (the y-z plane).

The first serrated surface 728 of the reflection suppression device 700 may be referred to herein as an input side of the reflection suppression device 700 (because the first serrated surface 728 receives the holographic wavefront). The second serrated surface 729 of the reflection suppression device 700 may be referred to herein as an output side of the reflection suppression device 700 (because the second serrated surface 729 emits the holographic wavefront once the holographic wavefront has propagated though the reflection suppression device 700).

The turning layer 703, in this example, also has a prismatic structure. However, the prism elements 735 of the turning layer 703 extend longitudinally in a direction that is orthogonal to the direction of extension of the prism elements of the first and second layers. Specifically, the prism elements 735 extend longitudinally in the y-direction rather than the x-direction. As such, the prism elements 735 are arranged to turn the holographic wavefront exclusively on the second plane (in the y-z plane) rather than on the first plane (the x-z plane).

A holographic wavefront (not shown) is first received by the turning layer 703, propagates through the turning layer 703 and is then emitted at an opposite side of the turning layer 703. As above, the prism elements 735 of the turning layer 703 extend substantially in the y direction so, in the y-z plane, the thickness of an individual prism element 730 for any given cross-section is substantially uniform. In particular, in the y-z plane, the surface of the turning layer 703 that receives the holographic wavefront is, in this example, substantially parallel to the opposing surface of the turning layer 703 that emits the holographic wavefront. Thus, the received and emitted holographic wavefront are parallel in the y-z plane. However, in a cross-section in the x-z plane, the thickness of an individual prism element 730 varies (in the x-direction). Thus, the received and emitted holographic wavefront are not parallel in the x-z plane. In other words, the turning layer 703 provides a net turn on the holographic wavefront which is exclusively in the x-z plane.

After being emitted by the turning layer 703, the holographic wavefront is received by the first serrated surface 728 of the first layer 720. The first turn (referred to above) on the holographic wavefront is provided by the first layer 720 as a result of the angle of the first serrated surface 728 and the refractive index of the first layer 720. In this example, the refractive index of the materials forming the first, intermediate, and second layers 720, 722, 724 is substantially the same. Thus, the holographic wavefront is not turned at either a first layer-intermediate layer interface or an intermediate layer-second layer interface as the holographic wavefront propagates through each respective layer. This is the case in both the x-z and y-z planes. When the holographic wavefront is emitted at the second serrated surface 729 of the second layer the second turn (referred to above) is provided by the second layer (as a result of the angle of the second serrated surface 729 and the refractive index of the second layer 724.

### Self-Cleaning External Surface of Waveguide

Accordingly, a head-up display for a vehicle, as described herein, may comprise a waveguide and associated components for the output of a spatially modulated wavefront, such as a holographic wavefront, to an eye-box as part of an optical sub-system (or “optical relay”). The transmission/exit surface forming the output surface of the waveguide may be an external surface, which is exposed to ambient conditions, including sunlight, humidity, dust and other contaminants. However, the external surface of the waveguide may be difficult to access for manual cleaning. In addition, when the waveguide comprises a reflection suppression component, as described above, manual cleaning may be difficult, ineffective and/or may risk damaging the array of prisms forming the external surface.

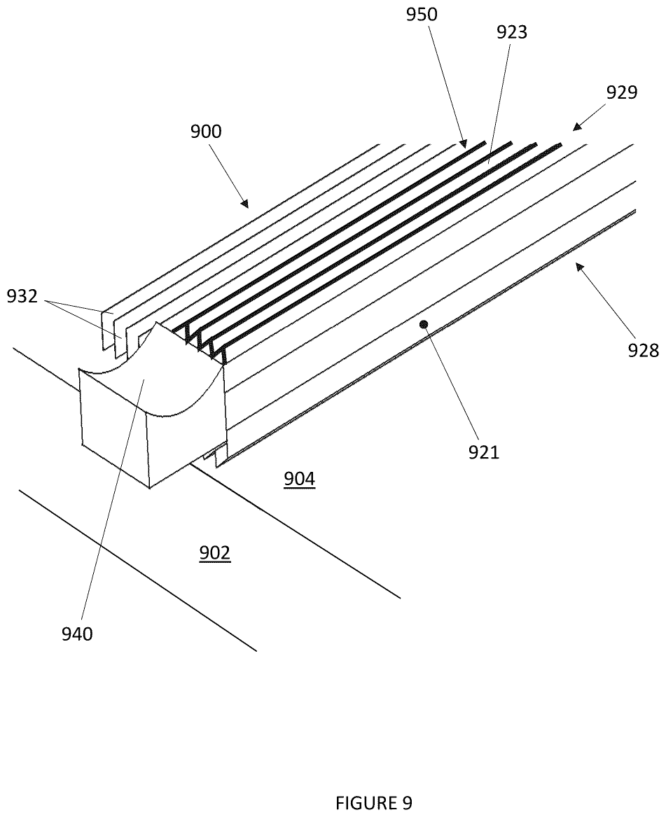

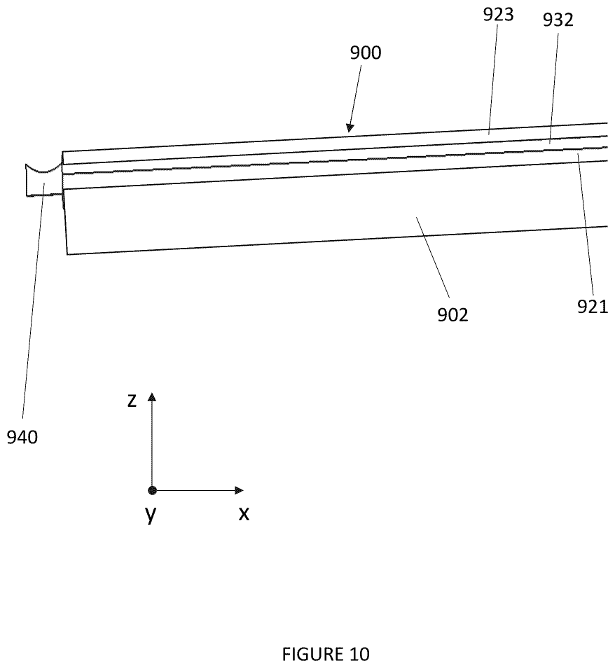

FIGS. 9 and 10 illustrate an example arrangement of a waveguide having a reflection suppression device comprising a self-cleaning external surface according to the present disclosure.

FIG. 9 shows a waveguide 902 comprising an output surface 904 for the formation and emission of replicas of a holographic light field encoded with a hologram of an image as described herein. The waveguide 902 comprises a reflection suppression device 900 arranged over the output surface 904. The reflection suppression device 900 corresponds to the reflection suppression device 700 of FIG. 7. Thus, as described above, reflection suppression device 900 comprises a three layered structure having a first prism layer comprising a first one-dimensional array of prism elements 921, an intermediate layer comprising an array of louvres 932 and a complementary second prism layer comprising a second one-dimensional array of prism elements 923.

Accordingly, a holographic wavefront emitted from output surface 904 of waveguide 902 is received by reflection suppression device 900 at an input side, comprising a first serrated surface 928 of the first one-dimensional array of prism elements 921, and is output from an output side, comprising a second serrated surface 929 of the second one-dimensional array of prism elements 923. In the example arrangement of FIG. 9, there is no light turning layer between the output surface 904 of the waveguide 902 and the reflection suppression component 900. In other arrangements, a light turning layer may be included as shown in FIG. 7.

Thus, an optical component comprising waveguide 902 and reflection suppression device 900 has an external surface, for the output of light of a picture to an eye-box, comprising the second serrated surface 929 of the second prism layer comprising a second one-dimensional array of prism elements 923.

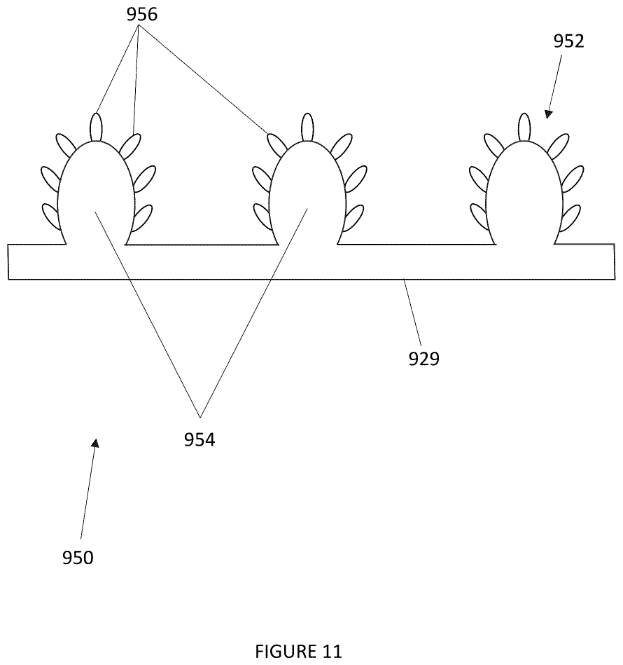

In accordance with the present disclosure, the second serrated surface 929 comprises a superhydrophobic surface structure layer 950. In particular, an array of hierarchical micro-nanostructures are provided at the second serrated surface 929 of the second one-dimensional array of prism elements 923. FIG. 9 shows the superhydrophobic surface structure layer 950 in black at the edges of prism elements 923 for ease of illustration. The superhydrophobic surface structure layer 950 covers or overlies the entire area of the second serrated surface 929. FIG. 11 illustrates an example superhydrophobic surface structure layer 950 comprising an array of hierarchical micro-nanostructures having a predefined template shape 952. In the illustrated example, the template shape comprises a micro pillar 954 with a plurality of nanofeatures 956 arranged on the surface of the micro pillar 954. As the skilled person will appreciate, the particular shape and arrangement of hierarchical micro-nanostructures comprising the superhydrophobic surface structure may be chosen according to application requirements.

As well known in the art, hierarchical micro-nanostructures provide a surface roughness or asperity that provides a superhydrophobic effect. In particular, water condensing on, or coming into contact with, the surface forms droplets (rather than a layer of liquid) on the surface due to the large contact angle. These droplets may rebound from the surface or, in the case of an inclined surface, roll off the surface whilst gathering and removing any surface contaminants. Thus, in addition to providing a water repellent effect, the hierarchical micro-nanostructures may remove surface dirt and other particulate contaminants, thereby providing a self-cleaning effect.

The example superhydrophobic surface structure layer 950 illustrated in FIG. 11 is formed as a separate layer from a suitable optically transparent material such as a polymer material, thermoplastics material (e.g. polycarbonate) or glass. The material of the layer may be matched to the material of the optical component. In particular, the superhydrophobic surface structure layer 950 may be formed of the same material as the optical component or a material that is refractive index matched to the material of the optical component. In examples, a sheet of optically transparent material may be processed to form the hierarchical micro-nanostructures in an upper surface thereof, such as by injection moulding, hot embossing and casting, laser ablation techniques or other suitable manufacturing methods. The resulting superhydrophobic surface structure layer 950 may then be formed (e.g. sized and shaped) as a cover or insert for overlying the external surface of the optical component. Thus, in the case that the optical component comprises a reflection suppression device 900 as described above, the superhydrophobic surface structure layer 950 may be formed to have a complementary shape to the second serrated surface 929 of the second prism layer comprising the second one-dimensional array of prism elements 928.

As the skilled person will appreciate, in other embodiments, the optical component itself may be manufactured with an external surface comprising the hierarchical micro-nanostructures. Accordingly, the superhydrophobic surface structure may be integrally formed with the optical component, rather than provided as a separate layer. Thus, in the case that the optical component comprises a reflection suppression device 900 as described above, the second serrated surface 929 of the second prism layer comprising the second one-dimensional array of prism elements 923 may comprise the hierarchical micro-nanostructures.

Returning to FIG. 9, the superhydrophobic surface structure layer 950 is formed over the second serrated surface 929 that forms the external surface of the optical component comprising waveguide 902 and reflection suppression device 900. Since a major face of each prism element of the second one-dimensional array of prism elements 923 is inclined, water (or other liquids) coming into contact with the external surface form droplets which roll down into the grooves between pairs of prism elements 923. In addition, as shown in FIG. 10, the optical component comprising waveguide 902 and reflection suppression device 900 is orientated, in situ, so that it is inclined at an angle relative to the horizontal plane. In consequence, the water droplets roll down the grooves between pairs of prism elements 923 towards a lowest side/edge (relative to the ground) of the optical component, and away from the external surface of the optical component. Thus, the external surface is provided with a self-cleaning effect that prevents liquid droplets and surface contaminants from collecting thereon, and so affecting the holographic wavefront output therefrom and detrimentally impacting image quality at the eye-box.

In the arrangement shown in FIG. 9, a drainage channel 940 is provided adjacent an edge of the external surface of the optical component. FIG. 9 shows only a small section of the drainage channel 940 for the purposes of illustration. In practice, the drainage channel extends along at least one edge of the optical component, in particular, on at least the side that is arranged to be lowest, when arranged in situ. The drainage channel 940 abuts the second one-dimensional array of prism elements 923 of the reflection suppression device 900 with its edge flush with, or slight below, the bottom of the grooves between the prism elements 923. In this way, water droplets rolling down the grooves between pairs of prism elements 923 roll into, and are collected within, the bottom of the drainage channel 940. The drainage channel 940 may be configured, or otherwise arranged, so that a lowest point of the channel recess is inclined towards an opening in the base of the channel 940 for emptying the water into a collection vessel or the like.

As the skilled person will appreciate, in other arrangements, a superhydrophobic surface structure may be provided on any other shaped external surface of an optical component. For example, when a reflection suppression device is not utilised, the external surface may be the output surface of a waveguide or the output surface of light turning layer formed over a waveguide, as described herein.

### Holographic Display

As described herein, a holographic display, such as a holographic head-up display, comprises a spatial light modulator and an optical sub-system (or “optical replay”). The spatial light modulator may be arranged with a light source. The spatial light modulator, such as a liquid on crystal spatial light modulator, may be arranged to be encoded with (or to “display”) a hologram of an image. The hologram may be received from a hologram engine arranged to calculate the hologram or from memory storing a plurality of precalculated holograms. The light source may be arranged to illuminate the hologram displayed on the spatial light modulator so that light is spatially modulated in accordance with the hologram. Thus, the spatially modulated light or wavefront output by the spatial light modulator comprises a holographic wavefront. The optical sub-system comprises at least one optical component arranged to provide an optical path for the holographic wavefront towards the viewing area or eye-box of the head-up display. For example, in the case of an automotive head-up display, as described above with reference to FIG. 6A, the optical sub-system may output the holographic wavefront toward a windscreen that reflects the holographic wavefront towards the eye-box. Thus, a viewer may perceive a virtual image of the picture in the windscreen. As described herein, at least one optical component of the optical sub-system may comprise at least one waveguide arranged as a pupil expander to increase the size of the eye-box. In addition, in some arrangements, a light turning layer and/or a reflection suppression device may be arranged at the exit/transmission surface (or output surface) of the waveguide. The output surface of the optical component may be an external surface, such that the holographic wavefront is transmitted through air from the external surface directly or indirectly to the eye-box. In accordance with the present disclosure, the external surface comprises a superhydrophobic surface structure for self-cleaning.

The presence of a superhydrophobic surface structure, for example comprising an array of hierarchical micro-nanostructures, at the output surface of the optical component will change the holographic wavefront, in particular the phase and/or amplitude of the spatially modulated light. Since the holographic wavefront comprises spatially modulated light in accordance with a hologram of an image, the optical effects of the superhydrophobic structures on the holographic wavefront may distort, or otherwise adversely affect, the quality of the image perceived at the eye-box.

A superhydrophobic surface structure is not conventionally used to provide self-cleaning on the surface of an optical component that propagates light comprising an image or image content, such as in display or image capture applications, since the surface roughness or asperity of the output surface would change the light field or wavefront, leading to distortions/aberrations in the image. However, the inventor realised that, in the case of an optical component that propagates a holographic wavefront in a holographic head-up display, it is nevertheless possible to use a superhydrophobic surface structure to provide self-cleaning by modifying the holographic wavefront received by the optical component so that an undistorted image is perceived at the eye-box.

Accordingly, the hologram of the image displayed on the spatial light modulator may pre-compensate for the optical effects of the superhydrophobic surface structure/hierarchical micro-nanostructures. In particular, in embodiments, a hologram of a target image to be displayed may be determined that pre-compensates the holographic wavefront output by the spatial light modulator. The pre-compensation corrects for the changes to phase and/or amplitude of the holographic wavefront due to the optical effects resulting from the presence of the superhydrophobic surface structure/hierarchical micro-nanostructures at the external surface of the optical component. Thus, a faithful, undistorted representation of the image is perceived by a viewer at the eye-box.

Techniques for optical pre-compensation in hologram calculation are known in the art (see, e.g., European patent 2936252 incorporated herein by reference). In particular, pre-compensation data may be determined. The pre-compensation data may be applied to a hologram of an image by a hologram engine. The pre-compensation data may be arranged to modify the hologram of an image so that the output holographic wavefront corrects for the optical effects of the superhydrophobic surface structure at the external surface of the optical component. Such techniques are possible due to the regular, periodic nature, and well-defined shape, of an array of hierarchical micro-nanostructures, which enables optical pre-compensation techniques to be synergistically used to compensate for the undesirable optical effects of the superhydrophobic surface structure.

Various techniques for determining the required pre-compensation for the superhydrophobic structure may be used. For example, simulation of the optical effects of a predetermined array of hierarchical micro-nanostructures on an output surface of an optical component may be performed. The parameters of the array of hierarchical micro-nanostructures used in the simulations may be measured from a manufactured example. The simulations may then be used to determine pre-compensation data representing the required phase and/amplitude changes to be applied to the wavefront output by the spatial light modulator so that the external surface of the optical component outputs the correct wavefront. The pre-compensation data may then be applied to a hologram of an image. In another example, calibration against a known target image may be used via closed-loop adjustment of the hologram generated at the spatial light modulator (e.g., LCOS).

It is envisaged that the above techniques may be used to determine an optimal shape and configuration of the superhydrophobic surface structure, in particular an array of hierarchical micro-nanostructures, for effective and efficient pre-compensation in accordance with application requirements.

Accordingly, there is provided a method of displaying an image. The method comprises displaying a hologram of the image on a spatial light modulator and illuminating the spatial light modulator with light. The method further comprises spatially modulating the light in accordance with the hologram and outputting the spatially modulated light as a holographic wavefront. The method additionally comprises receiving the holographic wavefront by an optical component having an external surface comprising a superhydrophobic surface structure. The method further comprises outputting the holographic wavefront by the external surface of the optical component to an eye-box. The hologram of the image is arranged to pre-compensate for the optical effects of the superhydrophobic surface structure.

In embodiments, the method comprises receiving and replicating the holographic wavefront output by the display device prior to output thereof to the eye-box.

In some embodiments, the method comprises determining a hologram of the image, and applying a pre-compensation (e.g. pre-compensation data) to the determined hologram to form the hologram of the image for display by the display device. The pre-compensation is arranged to modify the hologram so that the output holographic wavefront corrects for the optical effects of the superhydrophobic surface structure.

### Additional Features

The methods and processes described herein may be embodied on a computer-readable medium. The term “computer-readable medium” includes a medium arranged to store data temporarily or permanently such as random-access memory (RAM), read-only memory (ROM), buffer memory, flash memory, and cache memory. The term “computer-readable medium” shall also be taken to include any medium, or combination of multiple media, that is capable of storing instructions for execution by a machine such that the instructions, when executed by one or more processors, cause the machine to perform any one or more of the methodologies described herein, in whole or in part.

The term “computer-readable medium” also encompasses cloud-based storage systems. The term “computer-readable medium” includes, but is not limited to, one or more tangible and non-transitory data repositories (e.g., data volumes) in the example form of a solid-state memory chip, an optical disc, a magnetic disc, or any suitable combination thereof. In some example embodiments, the instructions for execution may be communicated by a carrier medium. Examples of such a carrier medium include a transient medium (e.g., a propagating signal that communicates instructions).

It will be apparent to those skilled in the art that various modifications and variations can be made without departing from the scope of the appended claims. The present disclosure covers all modifications and variations within the scope of the appended claims and their equivalents.

What is claimed is:

1. A head-up display for a vehicle, the head-up display comprising:
a spatial light modulator arranged to form a spatially modulated wavefront; and
an optical sub-system arranged to direct the spatially modulated wavefront to an eye-box, wherein the optical sub-system comprises an optical component having an external surface arranged to output light of an image to the eye-box, and wherein at least part of the external surface of the optical component comprises a superhydrophobic surface structure.

2. The head-up display of claim 1, wherein the superhydrophobic surface structure comprises a hierarchical micro-nanostructure.

3. The head-up display of claim 1, wherein the superhydrophobic surface structure comprises a layer on the external surface of the optical component, optionally wherein the layer is separate from, or integrally formed with, the optical component.

4. The head-up display of claim 1, wherein the optical component comprises a pupil expander arranged to output the spatially modulated wavefront and at least one replica thereof.

5. The head-up display of claim 1, wherein the optical component comprises a waveguide.

6. The head-up display of claim 1, wherein the optical component comprises a waveguide and a reflection suppression device arranged over an output surface of the waveguide, and wherein the external surface comprises an outer surface of the reflection suppression device.

7. The head-up display of claim 6, further comprising a light turning layer arranged between the output surface of the waveguide and an inner surface of the reflection suppression device.

8. The head-up display of claim 2, further comprising a drainage channel positioned adjacent to at least one edge of the optical component, wherein the drainage channel is arranged to collect liquid received from the hierarchical micro-nanostructure.

9. The head-up display of claim 8, wherein the liquid received from the hierarchical micro-nanostructure includes water comprising contaminants.

10. The head-up display of claim 8, wherein the optical component is arranged to be tilted from a horizontal plane, wherein, in use, the drainage channel is positioned adjacent at least one lowest edge of the tilted optical component such that liquid droplets formed on the external surface of the optical component are conveyed by gravity to the drainage channel.

11. The head-up display of claim 1, wherein the spatial light modulator is arranged to display a hologram of an image, and wherein the spatially modulated light comprises a holographic wavefront.

12. The head-up display of claim 11, wherein the hologram of the image displayed on the spatial light modulator is arranged to pre-compensate for optical effects of the superhydrophobic surface structure.

13. The head-up display of claim 1, further comprising a hologram engine arranged to calculate a hologram of an image, wherein the hologram engine is arranged to apply a pre-compensation to the hologram based on optical effects of the superhydrophobic surface structure so that a corrected holographic wavefront is output by the external surface of the optical component.

14. An optical component comprising:
an external surface arranged to output light of an image to an eye-box, wherein at least part of the external surface of the optical component comprises a superhydrophobic surface structure, wherein the optical component is configured for use in an optical sub-system arranged to direct a spatially modulated wavefront generated by a spatial light modulator to the eye-box.

15. The optical component of claim 14 further comprising:
a waveguide having a reflection suppression device arranged adjacent an output surface thereof, wherein the reflection suppression device comprises the external surface of the optical component.

16. The optical component of claim 14, further comprising:
at least one of a cover or an insert for the optical component, wherein the cover or insert comprises a superhydrophobic surface structure layer having a complementary configuration to the external surface of the optical component.

17. A method of displaying an image, the method comprising:
displaying a hologram of the image on a display device;
illuminating the display device with light;
spatially modulating the light in accordance with the hologram, wherein the spatially modulated light is output by the display device as a holographic wavefront;
receiving the holographic wavefront by an optical component having an external surface comprising a superhydrophobic surface structure; and
outputting, by the external surface of the optical component, the holographic wavefront to an eye-box, wherein the hologram of the image is arranged to pre-compensate for optical effects of the superhydrophobic surface structure.

18. The method of claim 17, further comprising:
receiving and replicating the holographic wavefront output by the display device.

19. The method of claim 17, further comprising:
determining a hologram of an image; and
applying pre-compensation to the determined hologram to form the hologram of the image for display by the display device, wherein the pre-compensation is arranged to modify the hologram so that the holographic wavefront output by the external surface of the optical component corrects for the optical effects of the superhydrophobic surface structure.

20. The method of claim 19, wherein applying pre-compensation comprises applying pre-compensation data.
